(19) United States
(12) Patent Application Publication
(10) Pub. No.: US 2009/0133407 A1
(43) Pub. Date: May 28, 2009

(54) PLASMA GASIFICATION SYSTEM

(75) Inventor: Alan Sawyer, Madison, NJ (US)

Correspondence Address: DUANE MORRIS LLP - Princeton, PO BOX 5203, PRINCETON, NJ, 08543-5203, US

(73) Assignee: NRG Energy, Inc., Princeton, NJ (US)

(21) Appl. No.: 12/274,473

(22) Filed: Nov. 20, 2008

Related U.S. Application Data
(60) Provisional application No. 60/990,763, filed on Nov. 28, 2007.

(51) Int. Cl. F02C 3/28; C10J 3/18

(52) U.S. Cl. 60/780; 48/65; 60/670; 60/39.12

(57) ABSTRACT

A system is disclosed for use in producing syngas for use in a variety of commercial applications, including commercial energy generation applications. A plasma torch and cupola arrangement are used to gasify feed stock such as coal, petcoke, and/or biomass, to produce syngas and liquid waste. The syngas is directed to a cleanup train, wherein detrimental components are mechanically or chemically filtered out. The cleaned syngas is then fed into a syngas burner and used to produce heat for electricity generation for the production of electricity or to another energy producing system including synthetic natural gas, ethanol, or liquid fuel oil. In some embodiments, the syngas is fed directly to a gas turbine. The liquid waste is cooled to generate in inert solid which may then be crushed and used in a variety of construction or other applications. The disclosed system may find use in new construction as well as retrofit applications.

### CROSS-REFERENCE TO RELATED APPLICATIONS

This is a non-provisional application of pending U.S. provisional patent application Ser. No. 60/990,763, filed Nov. 28, 2007, the entirety of which application is incorporated by reference herein.

### FIELD OF THE INVENTION

The invention relates generally to systems for producing and processing synthetic gas, and more particularly to a system for producing, cleaning and combusting synthetic gas produced by a plasma gasification reactor for use in a variety of downstream applications.

### BACKGROUND

The plasma processing of carbonaceous materials such as municipal solid waste (MSW) is known, and has been proposed as a means for eliminating large volumes of accumulated materials stored in urban and suburban landfills. The use of plasma torches provides advantages over incinerators or other combustion processes because the intense heat generated by the plasma torch (e.g., up to about ten thousand of degrees Fahrenheit) dissociates the waste material, causing the organic components of the waste to be turned to gas, and causing the inorganic components of the waste to be converted to a relatively small volume of inert vitrified material without combustion or incineration. The gaseous output is either filtered and collected or discharged, while the vitrified material is often used as an aggregate material amenable to a variety of construction uses.

Examples of current successful applications of plasma gasification technology include:

(1) General Motors power train plant located in Defiance, Ohio operates a plasma cupola for the production of gray iron in the making of engine blocks and other automotive castings.

(2) Alcan International operates a plasma furnace using plasma torches designed to recover aluminum from dross without using molten salt.

(3) Hitachi Metals has demonstrated the use of plasma gasification technology for MSW at a pilot plant located in Yoshii, Japan.

(4) Hitachi Metals has designed and constructed a MSW and sewage sludge treatment plant for the twin cities of Mihama and Mikata, Japan capable of up to 24 tons per day (TPD) of MSW and 4 TPD of sewage sludge.

(5) Hitachi Metals has designed and constructed the Utashinai Eco-Valley plant capable of gasifying up to 300 TPD of MSW and automobile shredder residue in Utashinai, Japan.

Plasma processing has been suggested for use in energy generation, but to date no large-scale installations have been implemented.

Thus there is a need for a plasma gasification system that can be effectively employed for the large scale commercial generation of energy. Such a system should be appropriate for new installations as well as for refit applications in existing coal-fired electricity generating facilities. The system should be flexible enough to enable the use of a variety of feed-stocks, including MSW, biomass, construction and demolition (C&D) residuals, coal and/or petcoke.

### SUMMARY OF THE INVENTION

A system for the generation of electrical energy is disclosed, comprising a plasma cupola, a plasma torch having an high temperature air output directed to a lower interior portion of the plasma cupola for heating materials disposed in the cupola, and a syngas cleanup train for accepting raw syngas output from a top region of the plasma cupola and removing unwanted constituents from the raw syngas to thereby produce refined syngas. The system may further comprise a vitrified waste collection system connected to a bottom region of the plasma cupola for outputting liquid waste from the cupola. A syngas boiler may be provided for burning the refined syngas to produce high-pressure steam. The system may further comprise a turbine for receiving the high-pressure steam and converting the energy from said steam into electricity. As an alternative to using a syngas boiler, the system may comprise a gas turbine, wherein the syngas may be fed into the gas turbine for use in a gas turbine simple cycle or combined cycle operation. The gas turbine may be configured to accept syngas in lieu of natural gas.

A plasma gasification system for energy generation is disclosed, comprising, a plasma gasifier comprising a plasma cupola and at least one plasma torch having an outlet for high temperature air (that may or may not be oxygen enriched) directed to an interior portion of the plasma cupola for converting feed stock material disposed within the cupola into raw syngas. The system may further comprise a syngas cleanup train connected to said plasma gasifier for receiving said raw syngas and for removing unwanted components from the raw syngas to produce cleaned syngas. A syngas burner system may also be provided for receiving and burning the cleaned syngas to produce high pressure steam. The system may also comprise a turbine connected to the syngas burner system for receiving the high pressure steam and converting it to electricity.

An energy generation system is disclosed, comprising, means for gasifying a feedstock to produce raw syngas, means for cleaning the raw syngas to remove a plurality of constituents, thereby producing refined syngas, and means for converting the refined syngas into electricity.

### DESCRIPTION OF THE DRAWINGS

The details of the invention may be obtained by a review of the accompanying drawings, in which like reference numerals refer to like parts, and in which:

FIG. 1 is a schematic representation of the disclosed plasma gasification system

### DETAILED DESCRIPTION

A system is disclosed for the gasification of coal and/or biomass feed stocks into a clean, synthetic gas (“syngas”) that is then combusted in a converted syngas boiler. Acceptable feed stocks may be any of a variety of materials, including MSW and highly organic feed stocks (e.g., coal, petcoke, and biomass).

Clean coal plasma gasification is an innovative application of proven technology. The commercial application of plasma gasification as a clean coal technology represents the collaboration of a number of advanced technologies, specifically: the design, application and operation of high temperature cupolas; the design, development and application of continuous operating high temperature plasma gas torches; as well as contaminant removal systems from power generation systems (i.e. particulate removal by fabric filter), mercury removal technologies used in the chemical industry (i.e. activated carbon bed filters), sulfur removal technologies from the natural gas processing industry (i.e. gas sweeteners via de-sulfurization process) and heat exchangers from the process and power generation industries (i.e. syngas coolers/HRSG).

Plasma Gasification and Cleanup System

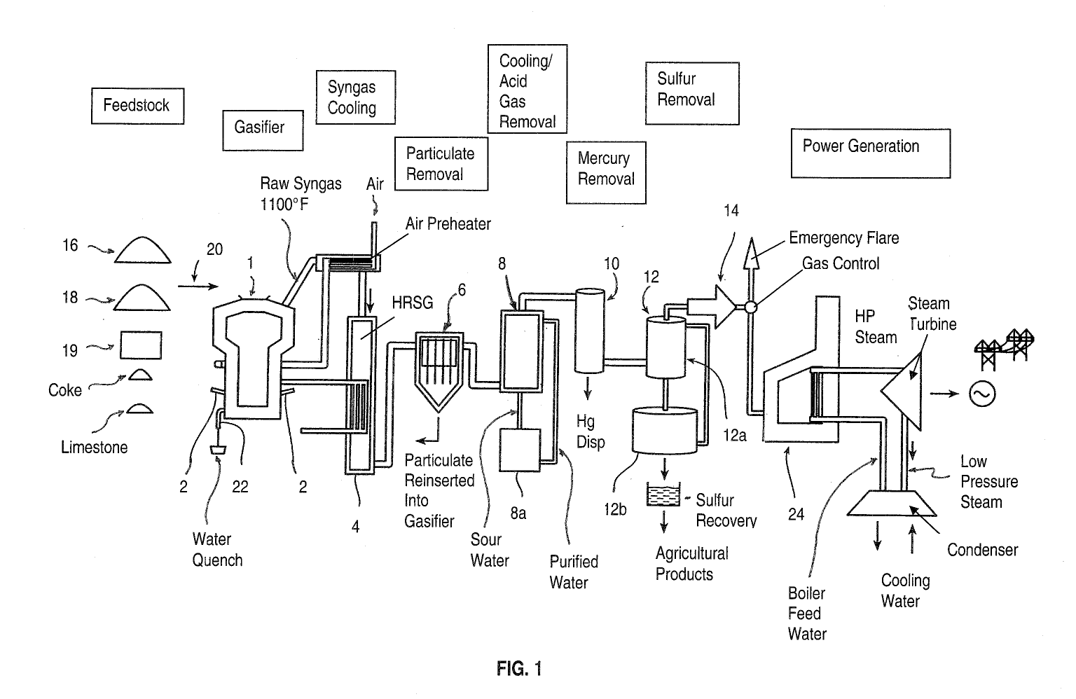

Plasma gasification technology along with a combination of commercially available syngas clean-up process equipment will convert the feedstocks (e.g. coal and biomass), into a clean synthetic gas. The syngas will be combusted in the syngas-fired boiler to power a steam-electric generating unit. The Plasma Gasification System (“PGS”) will consist of seven major components (FIG. 1):

Plasma Gasification Technology (cupola and plasma torches) (1, 2)

Syngas cooler 4

Particulate removal—baghouse and polishing wet quench/scrubber (6)

HCL/SO₂ acid gas removal—quench spray dryer (8)

Mercury removal—packed bed carbon filters (10)

H₂S (sulfur) removal—aqueous bio-desulfurization (12)

Intermediate syngas blower (14)

The plasma gasification system will consist of multiple steel and ceramic cupolas (1), each with plasma torches (2) (typically four or more per cupola) embedded through the side walls to create a very high temperature “plasma” zone (referred to as the heat affected zone) in the bottom of the cupola. The plasma gasification system (PGS) cupolas (1) will operate near atmospheric pressure with slight negative pressure to preclude any fugitive emissions. Coal and/or biomass and/or other organic material (including C&D, MSW, autofluff, etc.) feedstock (16, 18, 19) will be metered and controlled via the cupola feed system (20) (using either lock hopper or displacement screw mechanisms). Coal will be supplied to the cupolas (1) by the plant's coal receiving, storage and conveying system infrastructure. Biomass will be supplied to the cupolas (1) from a biomass receiving and storage structure and conveyor. Other feedstock will be supplied to the cupolas (1) by its receiving, storage and conveying system infrastructure

In one embodiment, a portion, and up to 100% of the total feed stock input may be supplied to the PGS cupola(s) as biomass in the form of wood (chips), woodwaste, and/or recycled paper derived fuel (paper cubes) depending on availability, market conditions, etc. Alternatively, coal, biomass, and other feedstock may be used together in any proportional combination (0%-100% biomass ˜100%-0% coal.) Where the feedstock is predominantly biomass, C&D, or MSW a minimum of about 4%-6% by weight of metcoke or coal may also be added (on a continual or batch basis along with the biomass feed) to maintain a gasification bed that encompasses the heat affected zone in the bottom portion of the cupola. Where the feedstock is predominantly coal, then the metcoke may be eliminated. The feedstock(s) will be controlled to create and maintain a gasification bed that completely covers the heat affected zone which will operate at approximately 6,000° F. Air, (air blown or oxygen enriched), will be blown through the plasma torches (2), heating the air to approximately 10,000° F. and converting it to what is referred to as the plasma state. This plasma is then injected into the gasification bed, interacts with the feedstock and rises to the top of the cupola, almost completely dissociating the feedstock (coal, biomass, etc.) into two streams, -1—gaseous organic material and -2—inorganic liquid (melted ash).

The gaseous stream consists of primarily hydrogen (H₂) and carbon monoxide (CO), which are the main combustible constituents of syngas. The melted inorganic slag will coalesce in melted liquid form (limestone is added to flux the liquid slag) and will be drained via a port or ports (22) on the bottom of the cupola to a water quench, where it will harden and shatter to a ground glass-like vitrified inert solid material, suitable for beneficial re-use in construction. Each cupola and plasma torch system is referred to as a single “gasifier.”

The synthetic gas created in the plasma gasification system will exit the gasifier(s) in the range of about 1,000° F. to about 2,500° F. (and in one embodiment approximately 1,900° F.), with low superficial velocity in order to minimize carry over of solid particulate. A typical air blown plasma gasification system using coal feedstock yields a gas composition as shown in Table 1 below.

TABLE 1
Typical Air-Blown PGS Coal Raw Gas Composition

| Composition | Wt % |
|---|---|
| CO | 35 |
| H₂ | 1 |
| N₂ | 58 |
| CO₂ | 4 |
| CₓH_{y} | <1 |
| H₂S | 1 |
| H₂O | 1 |

The plasma gasification system cupolas can be either air blown or oxygen enriched. Depending on final design selection, and in order to maintain unit reliability, one or more individual cupolas may be used to produce required syngas at a rate of up to about 1,284 MMBtu/hr, for producing about 120 MW of electrical power.

Syngas Cooler

Referring again to FIG. 1, a syngas cooler (4) (heat exchanger) is required to lower the temperature of the syngas exiting the cupola (1) to approximately 500° F., to allow for subsequent syngas clean-up. In one embodiment, the syngas cooler (4) will be matched to the existing steam cycle (where the system is used in refit applications) as a direct steam source and/or feedwater heater. Alternatively, the syngas cooler (4) may be matched to produce steam as input to the gasifier for applications in which system efficiency can be enhanced or optimized through such an arrangement. The exit temperature of the syngas cooler is limited by the raw syngas acid gas dew point. One syngas cooler will be used for the combined plasma gasification system cupolas output (e.g., four).

Acid Gas and Particulate Removal

The next two stages in the plasma gasification system consist of initial acid gas knock out and particulate removal components. The first device is a nitrogen pulsed baghouse (6) (i.e., fabric filter) for fine particulate removal. Next, the syngas will be directed to a wet quench scrubber (8). The device, which is similar to a spray dryer is designed to capture acid gases (HCl, SO₂, and NH₃) and to further cool the syngas, thus condensing particulate aerosols. Syngas will exit the quench scrubber at approximately 240° F. and will next flow through a polishing wet scrubber (8A) which will then further condense aerosols and will capture any residual acid gases, filterable particulate and condensable particulate not captured in the primary gas cleanup systems. Solid particulate captured in the baghouse (6) is recycled back to the cupolas (1) to be converted to recyclable slag. It will be appreciated that in some embodiments the wet quench scrubber (8) may be placed upstream of the baghouse (6).

Mercury Removal

An activated carbon filter (10) will next capture mercury from the syngas (the mercury in coal feedstock is liberated as elemental mercury vapor within the high temperature environment of the gasifiers). The carbon filter may be either a single bed or dual carbon beds in series, with break-through mercury monitoring in-between for added protection. Each carbon bed is capable of adsorbing nearly all of the incoming Hg up until saturation, referred to as break-through. By monitoring mercury break-through at the outlet of the first bed, the second or “guard bed” will still capture mercury at high efficiency; however the operators will know that the first bed needs to be replaced. The flow of syngas will then be swapped, the second bed will become the first bed, and a new fresh guard bed will be installed to take its place. Carbon, once Hg saturated, requires disposal in a regulated hazardous waste landfill. It is expected that one carbon bed will need to be changed out and disposed of every other year, depending on their size.

Sulfur Removal

While acid gases such as HCl and SO₂ are removed in the wet quench scrubber stage (8) of the syngas cleanup train, that stage may be ineffective at capturing hydrogen sulfide (H₂S), a major source of sulfur in raw syngas. Research indicates that there are three demonstrated and commercially available processes available for low pressure H₂S removal, referred to by the trade names Shell Pâques, LowCat, and SulfurOx. In one embodiment, an additional filtration arrangement (12) is used, one example of which may be the “Shell Pâques” system (from Natco), which consists of one or more packed tower aqueous contactor(s) (12A), bioreactor(s) (12B), and interconnecting equipment. The system uses an aqueous soda solution containing thiobacillus bacteria. The soda solution absorbs the H₂S and is then circulated through one or more aerated atmospheric bioreactor tanks. Within the bioreactor tanks the bacteria biologically convert the scrubbed H₂S to elemental sulfur. The biological sulfur slurry produced may be beneficially re-used for agricultural purposes or may be purified to a high quality (99%+) sulfur cake product for sale. The biological organisms employed to reduce H₂S to elemental sulfur will also consume small amounts of ambient CO₂. The specific bacteria used in the Shell Pâques system do not emit odor during sulfur removal or natural decay. A potential byproduct of the process is an agricultural fertilizer which may prove capable of increasing the growth rate (and CO₂ adsorption) of biomass.

### Syngas Boiler

An integrated syngas-fired boiler (24) employing low NOₓ design syngas burners will be used to combust the produced syngas. For flame safety concerns up to 10% of total heat input may need to be co-fired as a liquid fuel (oil or bio-diesel) pilot flame, to ensure flame stabilization and system safety.

If used in a coal boiler refit application, existing systems may be retained to aid in overall NOx reduction, including a Selective Non-catalytic Reduction (SNCR) system to ensure that proposed NOₓ limits can be met under all conditions. It is contemplated, however, that local governmental air requirements may make it possible to forego use of the electrostatic precipitators in some embodiments.

The described system may have a generation capacity of 120 MW net (132 MW gross). The disclosed systems, as described, may also be capable of utilizing a wide range of feed stocks to produce the 120 MW net capability under all operating conditions.

Further, the disclosed system may be used for the efficient production of syngas that can then be used in a wide variety of applications. For example, the syngas produced and processed using the disclosed system can be converted to other products, such as ethanol, through processes such as bacterial decomposition and the like. Coal-to-liquids production may also be facilitated through the use and appropriate adaptation of all or a portion of the disclosed system.

Thus, it will be understood that the description and drawings presented herein represent an embodiment of the invention, and are therefore merely representative of the subject matter that is broadly contemplated by the invention. It will be further understood that the scope of the present invention encompasses other embodiments that may become obvious to those skilled in the art, and that the scope of the invention is accordingly limited by nothing other than the appended claims.

1. A system for the production and processing of syngas, comprising:
a plasma cupola;
a plasma torch having a high temperature air output that may or may not be oxygen enriched directed to a lower interior portion of the plasma cupola for heating materials disposed in the cupola;
a syngas cleanup train for accepting raw syngas output from a top region of the plasma cupola and removing unwanted constituents from the raw syngas to thereby produce refined syngas;
a vitrified waste collection system connected to a bottom region of the plasma cupola for outputting liquid waste from the cupola; and
a syngas boiler for burning the refined syngas to produce high-pressure steam; and
a turbine for receiving the high-pressure steam and converting the energy from said steam into electricity, or
a gas turbine or combustion machine to receive the clean syngas directly for the generation of electricity in a gas turbine simple cycle, gas turbine combined cycle, or internal combustion engine power generation system, or
any other process that uses refined syngas as an input product including the production of synthetic natural gas, ethanol, or diesel liquid fuel.

2. The system of claim 1, wherein the syngas cleanup train further comprises a syngas cooler coupled to a heat recovery steam generator, the heat recovery steam generator further being coupled to the plasma cupola to provide heat energy input back to the cupola or to provide heat to the integrated electric generation cycle.

3. The system of claim 2, wherein the syngas cleanup train further comprises a baghouse for removing particulates from the syngas, a quench tank, and an activated carbon filter for removing mercury from the syngas.

4. The system of claim 3, wherein the syngas cleanup train further comprises a bio-reactor for removing sulfur from the syngas, and a blower for increasing the syngas inlet pressure to the syngas burner or combustion machine.

5. The system of claim 4, further comprising a syngas boiler coupled to a turbine loop comprising a steam turbine and a condenser, wherein high pressure steam provided from the boiler turns the turbine to produce electricity.

6. The system of claim 4, further comprising a gas turbine in either simple or combined cycle operation or an internal combustion engine to produce electricity.

7. The system of claim 4, further comprising a supplemental process that uses refined syngas as an input product for the production of synthetic natural gas, ethanol, or liquid fuel oils.

8. A system for energy generation, comprising:
a plasma gasifier comprising a plasma cupola and at least one plasma torch having a high temperature air outlet that may or may not be oxygen enriched directed to an interior portion of the plasma cupola for converting feed stock material disposed within the cupola into raw syngas;
a syngas cleanup train connected to said plasma gasifier for receiving said raw syngas and for removing unwanted components from the raw syngas to produce cleaned syngas;
wherein the syngas cleanup train further comprises a syngas cooler coupled to a heat recovery steam generator, the heat recovery steam generator further being coupled to the plasma cupola to provide heat energy input back to the cupola or to provide heat input to the integrated electric generation cycle.

9. The system of claim 8, wherein the raw syngas cleanup train further comprises a baghouse for removing particulates from the raw syngas, a quench tank, and an activated carbon filter for removing mercury from the raw syngas.

10. The system of claim 9, wherein the syngas cleanup train further comprises a bio-reactor for removing sulfur from the syngas, and a blower for increasing the syngas inlet pressure to the syngas burner.

11. The system of claim 10, further comprising a syngas boiler for receiving and burning the cleaned syngas to produce high pressure steam coupled to a turbine loop comprising a steam turbine and a condenser, wherein high pressure steam provided from the boiler turns the turbine to produce electricity, or
a gas turbine or combustion machine to receive the clean syngas directly for the generation of electricity in a gas turbine simple cycle, gas turbine combined cycle, or internal combustion engine power generation system.

12. The system of claim 11, wherein the plasma torch is capable of heating air that may or may not be oxygen enriched to a temperature of about 10,000 degrees Fahrenheit.

13. An energy generation system, comprising:
means for gasifying a feedstock to produce raw syngas;
means for cleaning the raw syngas to remove a plurality of constituents, thereby producing refined syngas; and
means for converting the refined syngas into electricity.

14. The energy generation system of claim 13, wherein the means for gasifying a feedstock comprises a plasma cupola and at least one plasma torch having a high temperature air outlet directed to an interior portion of the plasma cupola.

15. The energy generation system of claim 14, wherein the means for cleaning the raw syngas comprises a syngas cooler coupled to a heat recovery steam generator, the heat recovery steam generator further being coupled to the plasma cupola to provide heat energy input back to the cupola or to provide heat to the integrated electric generation cycle.

16. The plasma gasification system of claim 15, wherein the means for cleaning the raw syngas further comprises a baghouse or removing particulates from the raw syngas, a quench tank, and an activated carbon filter for removing mercury from the raw syngas.

17. The plasma gasification system of claim 16, wherein the means for cleaning the syngas further comprises a bio-reactor for removing sulfur from the syngas, and a blower for increasing the syngas inlet pressure to the syngas burner.

18. The plasma gasification system of claim 17, wherein the means for converting the refined syngas into electricity comprises a syngas burner system for receiving and burning the cleaned syngas to produce high pressure steam; and a turbine connected to the syngas burner system for receiving the high pressure steam and converting it to electricity, or
a gas turbine or combustion machine to receive the clean syngas directly for the generation of electricity in a gas turbine simple cycle, gas turbine combined cycle, or internal combustion engine power generation system.
